(19) United States
(12) Patent Application Publication
(10) Pub. No.: US 2002/0120876 A1
(43) Pub. Date: Aug. 29, 2002

(54) Electronic communication

(75) Inventors: Siani Lynne Pearson, Bristol (GB); Robert Thomas Owen Rees, Newport (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/080,466

(22) Filed: Feb. 22, 2002

(30) Foreign Application Priority Data
Feb. 23, 2001 (GB) 0104587.1

(51) Int. Cl. G06F 11/30

(52) U.S. Cl. 713/201; 709/225

(57) ABSTRACT

A service-provider 600 including a physically and logically protected computing environment 401, and a user space 402 accepts a request 604 to provide a private virtual room for a particular purpose from a customer or multiple customers 606. At 702, it checks the legitimacy of the proposed purpose and seeks input about the criteria for filtering the participants. Providing the legitimacy of the proposed purposes are verified, at 703 the service-provider 600 sets up the private virtual room 608 which provides a secure environment within which participants can communicate electronically. At 704, the service-provider 600 receives requests from potential participants 610 to enter the virtual room 608, and its filters the participants 610 to ensure they meet previously-defined criteria.

### FIELD OF THE INVENTION

This invention relates to electronic communication between two or more parties and, in particular, to a method and apparatus for providing a secure environment within which such electronic communication can take place.

### BACKGROUND TO THE INVENTION

With the increase in commercial activity transacted over the Internet, known as “e-commerce”, there has been much interest in the prior art on enabling data transactions between computing platforms over the Internet. However, because of the potential for fraud and manipulation of electronic data, in such proposals, fully automated transactions with distant unknown parties on a wide-spread scale as required for a fully transparent and efficient market place have so far been held back. The fundamental issue is one of trust between interacting computer platforms (and their users) for the making of such transactions.

In the applicant's co-pending International Patent Application Publication No. PCT/GB00/00528 entitled ‘Trusted Computing Platform’, filed on Feb. 15, 2000, the entire contents of which are incorporated herein by reference, and International Patent Application Publication No. PCT/GB00/00751 entitled ‘Computing Apparatus and Methods Using Secure Authentication Arrangement’ filed on Mar. 3, 2000, there is disclosed a concept of a ‘trusted computing platform’ comprising a computing platform which has a ‘trusted component’ in the form of a built-in hardware and software component. Two computing entities each provisioned with such a trusted component may interact with each other with a high degree of ‘trust’. That is to say, where the first and second computing entities interact with each other, the security of the transaction enhanced compared to the case where no trusted component is present, because:

i) A user of a computing entity has higher confidence in the integrity and security of his/her own computer entity and in the integrity and security of the computer entity belonging to the other computing entity.

ii) Each entity is confident that the other entity is in fact the entity which it purports to be.

iii) Where one or both of the entities represent a party to a transaction, e.g. a data transfer transaction, because of the built-in trusted component, third party entities interacting with the entity have a high degree of confidence that the entity does in fact represent such a party.

iv) The trusted component increases the inherent security of the entity itself, through verification and monitoring processes implemented by the trusted component.

v) The computer entity is more likely to behave in the way it is expected to behave.

Prior art computing platforms have several problems which need to be overcome in order to realise the potential of the applicants' above-disclosed trusted component concept. In particular,

the operating status of a computer system or platform and the status of the data within the platform or system is dynamic and difficult to predict;

it is difficult to determine whether a computer platform is operating correctly because the state of the computer platform and data on the platform is constantly changing and the computer platform itself may be dynamically changing;

from a security point of view, commercial computer platforms, in particular client platforms, are often deployed in environments which are vulnerable to unauthorised modification. The main areas of vulnerability include modification by software loaded by a user, or by software loaded via a network connection. Particularly, but not exclusively, conventional computer platforms may be vulnerable to attack by virus programs, with varying degrees of hostility;

computer platforms may be upgraded or their capabilities extended or restricted by physical modification, i.e. addition or deletion of components such as hard disk drives, peripheral drivers and the like.

In particular, conventional computer platforms are susceptible to attack by computer viruses, of which there are thousands of different varieties. Several proprietary virus finding and correcting applications are known. However, such virus packages protect primarily against known viruses, and new strains of virus are being developed and released into the computing and Internet environment on an ongoing basis.

In the applicant's International Patent Application No. PCT/GB00/02003 entitled ‘Data Integrity Monitoring in Trusted Computing Entity’, filed on May 25, 2000, the entire contents of which are incorporated herein by reference, there is disclosed the concept of a computer platform with a trusted component which generates integrity metrics describing the integrity of data on the computer platform, which can be reported to a user of the computer platform, or to a third party entity communicating with the computer platform, for example over a network connection, thereby providing a higher level of trustworthiness and security.

However, in the event that two or more parties wish to communicate, trade or carry out business over the Internet, no provision is made to prevent unwanted third parties from gaining unauthorised access to confidential information, i.e. “listening in” to the communication. Further, the arrangement described in the applicant's above-mentioned prior disclosure only monitors and reports the integrity of the computer platform, it does not verify the integrity of the user of the computer platform or their suitability to be a party to the communication or transaction in question.

### SUMMARY OF THE INVENTION

We have now devised an arrangement which overcomes the problems outlined above. Thus, in accordance with a first aspect of the present invention, there is provided apparatus for providing a private virtual room within which two or more parties can communicate electronically, the apparatus comprising means for receiving a request from at least one party to provide said virtual room, said request including information regarding the proposed purpose of said virtual room, the apparatus further comprising means for verifying the legitimacy of said proposed purpose and providing said virtual room only if said proposed purpose meets one or more predetermined criteria.

In accordance with a second aspect of the present invention, there is provided apparatus for providing a private virtual room within which two or more parties can communicate electronically, the apparatus comprising means for receiving a request from at least one party to enter said virtual room, means for defining predetermined criteria for entry into said virtual room, and means for permitting a party to enter said virtual room only if said party satisfies said predetermined common criteria.

In accordance with a third aspect of the present invention, there is provided apparatus for providing a private virtual room within which two or more parties can communicate electronically, the apparatus comprising means for providing at least one virtual room and for running said virtual room within its own physically and logically protected computing environment (e.g. a “compartment”), and means for verifying the integrity of data within the or each said environment.

The first, second and third aspects of the present invention also extend to a method of providing a private virtual room corresponding to the respective apparatus as defined above.

The apparatus beneficially comprises means for receiving a request from a user to provide a private virtual room for a specified purpose, and for verifying the legitimacy of said purpose. The apparatus preferably also comprises means for determining if a user computing platform includes a logically and physically protected computing environment.

The apparatus preferably comprises means for receiving and storing criteria which are required to be met by a user before access to the private virtual room will be permitted. The apparatus preferably comprises means for receiving a request from a user for entry to the private virtual room, means for determining if the requesting user satisfies all of the predefined criteria and for permitting access of the requesting user to the private virtual room only if all of said criteria are satisfied.

The apparatus is preferably adapted to provide a plurality of private virtual rooms upon demand, each of the virtual rooms being run in a logically and physically protected computing environment, preferably a compartment. The apparatus is preferably arranged such that only encrypted data is permitted to enter or leave a compartment. In a preferred embodiment of the present invention, the apparatus is provided with encryption means for encrypting such data, such that it can only be decrypted with permission from the apparatus.

The apparatus is preferably arranged to perform integrity checks on its hardware and software environment prior to providing a requested private virtual room, and only setting up such a virtual room if the environment is determined to be suitable. The apparatus preferably also includes means for performing integrity checks on its software environment while a private virtual room is in use.

The apparatus may comprise means for displaying or otherwise providing details of one or more attributes of a user of a private virtual room to other users of the virtual room. In a preferred embodiment of the invention, means are provided to produce logs of the communication or interaction taking place within a private virtual room and to store the logs in a protected storage means. Beneficially, the logs are stored using a key known only to the apparatus of the invention.

### BRIEF DESCRIPTION OF THE DRAWINGS

An embodiment of the present invention will now be described by way of example only and with reference to the accompanying drawings, in which:

FIG. 1 is a diagram which illustrates a computing platform containing a trusted device and suitable for use in embodiments of the present invention;

FIG. 2 is a diagram which illustrates a motherboard including a trusted device arranged to communicate with a smart card via a smart card reader and with a group of modules;

FIG. 3 is a diagram which illustrates the trusted device in more detail;

FIG. 4 is a diagram which illustrates schematically the logical architecture of a computing platform as shown in FIG. 1 and adapted for use in embodiments of the present invention; and

FIG. 5 is a schematic representation illustrating interactions between a requester and a service-provider in embodiments of the present invention.

### DETAILED DESCRIPTION OF THE INVENTION

In the following description, numerous specific details are set forth in order to provide a thorough understanding of the present invention. It will be apparent, however, to one skilled in the art, that the invention may be practised without limitation to these specific details. In other instances, well known methods and structures have not been described in detail so as to avoid unnecessarily obscuring the present invention.

Before describing a specific exemplary embodiment of the present invention, a trusted computing platform of a type generally suitable for carrying out an embodiment of the present invention will be described by way of example only with reference to FIGS. 1 to 4. This description of a trusted computing platform describes the essential elements of its construction, its role in providing integrity metrics indicating the state of the computing platform to a user of that platform, and communication of such metrics to a user. A “user” in this context may be a remote user such as a remote computing entity. A trusted computing platform is further described in the applicant's co-pending International Patent Application No. PCT/GB00/00528 entitled ‘Trusted Computing Platform’ and filed on Feb. 15, 2000, the contents of which are incorporated herein by reference.

A trusted computing platform of the kind described here is a computing platform into which is incorporated a physical trusted device whose function is to bind the identity of the platform to reliably measured data that provides an integrity metric of the platform. The identity and the integrity metric are compared with expected values provided by a trusted party (TP) that is prepared to vouch for the trustworthiness of the platform. If there is a match, the implication is that at least part of the platform is operating correctly, depending on the scope of the integrity metric.

A user verifies the correct operation of the platform before exchanging other data with the platform. A user does this by requesting the trusted device to provide its identity and an integrity metric. (Optionally the trusted device will refuse to provide evidence of identity if it itself is unable to verify correct operation of the platform). The user receives the proof of identity and the integrity metric, and compares them against values which it believes to be true. Those proper values are provided by the TP or another entity which is trusted by the user. If data reported by the trusted device is the same as that provided by the TP, the user trusts the platform. This is because the user trusts the entity. The entity trusts the platform because it has previously validated the identity and determined the proper integrity metric of the platform.

Once a user has established trusted operation of the platform, he exchanges other data with the platform. For a local user, the exchange might be by interacting with some software application running on the platform. For a remote user, as will generally be the case in embodiments of the present invention, the exchange might involve a request for the provision of a private virtual room. In either case, the data is ‘signed’ by the trusted device. The user can then have greater confidence that data is being exchanged with a platform whose behaviour can be trusted.

The trusted device uses cryptographic processes but does not necessarily provide an external interface to those cryptographic processes. Also, a most desirable implementation would be to make the trusted device tamper-proof, to protect secrets by making them inaccessible to other platform functions and provide an environment which is substantially immune to unauthorised modification. Since tamper-proofing is considered virtually impossible, the best approximation is a trusted device that is tamper-resistant, or tamper-detecting. The trusted device, therefore, preferably consists of one physical component which is tamper-resistant. Techniques relevant to tamper-resistance are well known to those skilled in the art. However, it will be appreciated that, although tamper-resistance is a highly desirable feature of the present invention, it does not enter into the normal operation of the present invention and, as such, is beyond the scope of the present invention and will not be described in any detail herein.

The trusted device is preferably a physical one because it is necessarily difficult to forge. It is most preferably tamper-resistant because it is necessarily difficult to counterfeit. It typically has an engine capable of using cryptographic processes because it is required to prove identity, both locally and at a distance, and it contains at least one method of measuring some integrity metric of the platform with which it is associated.

A trusted platform 10 is illustrated in FIG. 1. The platform 10 includes the standard features of a keyboard 14, a mouse 16 and visual display unit (VDU) 18, which provide the physical ‘user interface’ of the platform. This embodiment of a trusted platform also contains a smart card reader 12, although this is not essential in all embodiments of the present invention. Alongside the smart card reader 12, there is illustrated a smart card 19 to allow trusted user interaction with the trusted platform (this aspect is further described in the applicant's co-pending International Patent Application No. PCT/GB00/00751, entitled ‘Computing Apparatus and Methods Using Secure Authentication Arrangement’, and filed on Mar. 3, 2000, the contents of which application are incorporated herein by reference). In the platform 10, there are a plurality of modules 15:these are other functional elements of the trusted platform of essentially any kind appropriate to that platform (the functional significance of such elements is not relevant to the present invention and will not be discussed further herein).

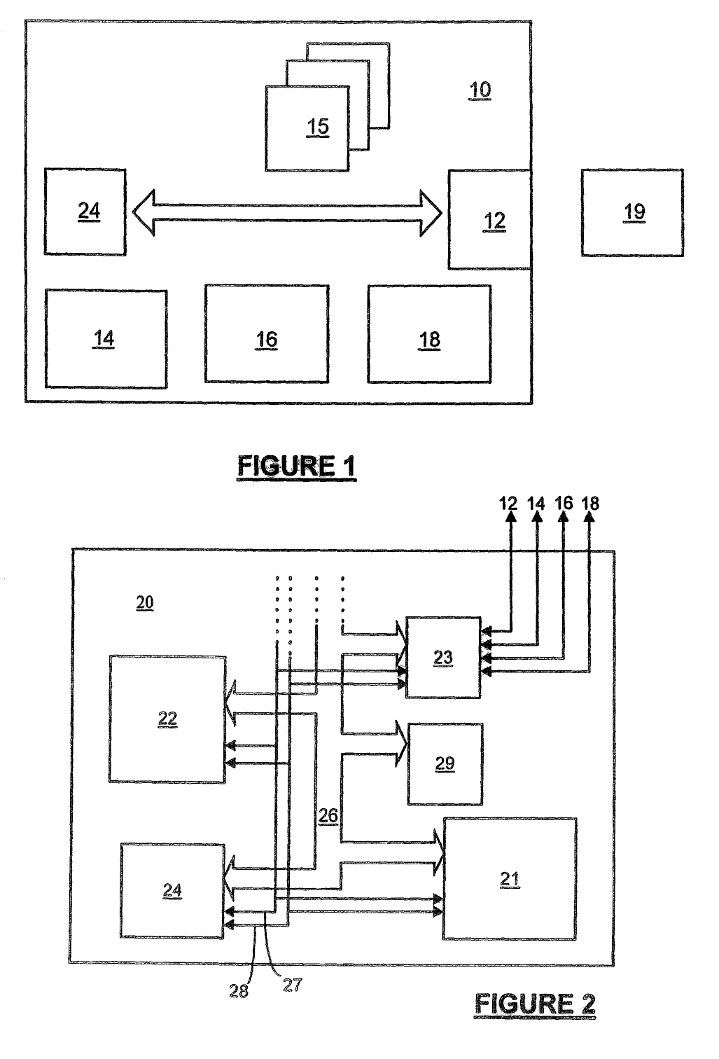

As illustrated in FIG. 2, the motherboard 20 of the trusted computing platform 10 includes (among other standard components) a main processor 21, main memory 22, a trusted device 24, a data bus 26 and respective control lines 27 and address lines 28, BIOS memory 29 containing the BIOS program for the platform 10 and an Input/Output (I/O) device 23, which controls interaction between the components of the motherboard and the smart card reader 12, the keyboard 14, the mouse 16 and the VDU 18. The main memory 22 is typically random access memory (RAM). In operation, the platform 10 loads the operating system into RAM from hard disk (not shown).

Typically, in a personal computer, the BIOS program is located in a special reserved memory area, the upper 64K of the first megabyte of the system memory (addresses F000h to FFFh), and the main processor is arranged to look at this memory location first, in accordance with an industry-wide standard.

The significant difference between the trusted platform and a conventional platform is that, after reset, the main processor is initially controlled by the trusted device, which then hands control over to the platform-specific BIOS program, which in turn initialises all input/output devices as normal. After the BIOS program has executed, control is handed over as normal by the BIOS program to an operating system program, which is typically loaded into the main memory 22 from a hard disk drive (not shown).

Clearly, this change from the normal procedure requires a modification to the implementation of the industry standard, whereby the main processor 21 is directed to address the trusted device 24 to receive its first instructions. This change may be made by simply hard-coding a different address into the main processor 21. Alternatively, the trusted device 24 may be assigned the standard BIOS program address, in which case there is no need to modify the main processor configuration.

It is highly desirable for the BIOS boot block to be contained within the trusted device 24. This prevents subversion of the obtaining of the integrity metric (which could otherwise occur if rogue software processes are present) and prevents rogue software processes creating a situation in which the BIOS (even if correct) fails to build a proper environment for the operating system.

Although in the trusted computing platform to be described, the trusted device 24 is a single, discrete component, it is envisaged that the functions of the trusted device 24 may alternatively be split into multiple devices on the motherboard, or even integrated into one or more of the existing standard devices of the platform. For example, it is feasible to integrate one or more of the functions of the trusted device into the main processor itself, provided that the functions and their communications cannot be subverted. This, however, would probably require separate leads on the processor for sole use by the trusted functions. Additionally or alternatively, although in the present invention the trusted device is a hardware device which is adapted for integration into the motherboard 20, it is anticipated that a trusted device may be implemented as a ‘removable’ device, such as a dongle, which could be attached to a platform when required. Whether the trusted device is integrated or removable is a matter of design choice. However, where the trusted device is separable, a mechanism for providing a logical binding between the trusted device and the platform is preferably present.

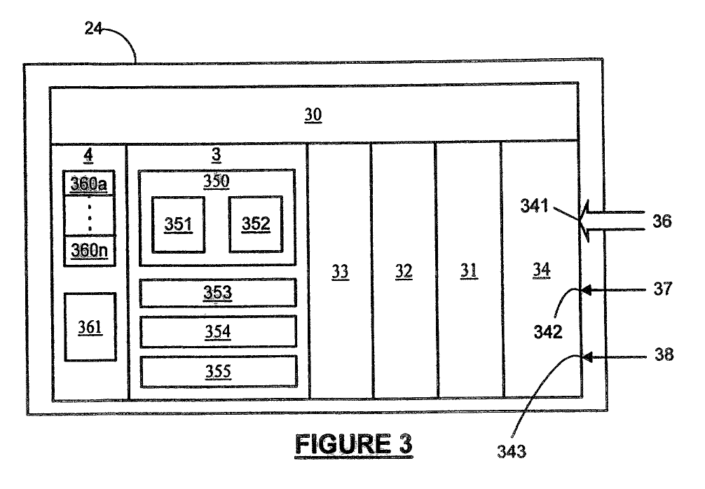

The trusted device 24 comprises a number of blocks, as illustrated in FIG. 3. After system reset, the trusted device 24 performs a secure boot process to ensure that the operating system of the platform 10 (including the system clock and the display on the monitor) is running properly and in a secure manner. During the secure boot process, the trusted device 24 acquires an integrity metric of the computing platform 10. The trusted device 24 can also perform secure data transfer and, for example, authentication between it and a smart card via encryption/decryption and signature/verification. The trusted device 24 can also securely enforce various security control policies, such as locking of the user interface.

Specifically, the trusted device comprises: a controller 30 programmed to control the overall operation of the trusted device 24, and interact with the other functions on the trusted device 24 and the other devices on the motherboard 20; a measurement function 31 for acquiring the integrity metric from the platform 10; a cryptographic function 32 for signing, encrypting or decrypting specified data; an authentication function 33 for authenticating a smart card; and interface circuitry 34 having appropriate ports (36, 37 & 38) for connecting the trusted device 24 respectively to the data bus 26, control lines 27 and address lines 28 of the motherboard 20. Each of the blocks in the trusted device 24 has access (typically via the controller 30) to appropriate volatile memory areas 4 and/or non-volatile memory areas 3 of the trusted device 24. Additionally, the trusted device 24 is designed, in a known manner, to be tamper-resistant.

For reasons of performance, the trusted device 24 may be implemented as an application specific integrated circuit (ASIC). However, for flexibility, the trusted device 24 is preferably an appropriately programmed micro-controller. Both ASICs and micro-controllers are well known in the art of microelectronics and will not be considered herein in any further detail.

One item of data stored in the non-volatile memory 3 of the trusted device 24 is a certificate 350. The certificate 350 contains at least a public key 351 of the trusted device 24 and an authenticated value 352 of the platform integrity metric measured by a trusted party (TP). The certificate is signed by the TP using the TP's private key prior to it being stored in the trusted device 24. In later communications sessions, a user of the platform 10 can verify the integrity of the platform 10 by comparing the acquired integrity metric with the authentic integrity metric 352. If there is a match, the user can be confident that the platform 10 has not been subverted. Knowledge of the TP's generally-available public key enables simple verification of the certificate 350. The non-volatile memory 3 also contains an identity (ID) label 353. The ID label is a conventional ID label, for example a serial number, that is unique within some context. The ID label 353 is generally used for indexing and labelling of data relevant to the trusted device 24, but is insufficient in itself to prove the identity of the platform 10 under trusted conditions.

The trusted device 24 is equipped with at least one method of reliably measuring or acquiring the integrity metric of the computing platform 10 with which it is associated. In this exemplary embodiment, the integrity metric is acquired by the measurement function 31 by generating a digest of the BIOS instructions in the BIOS memory. Such an acquired integrity metric, if verified as described above, gives a potential user of the platform 10 a high level of confidence that the platform 10 has not been subverted at a hardware, or BIOS program, level. Other known processes, for example virus checkers, will typically be in place to check that the operating system and application program code have not been subverted.

The measurement function 31 has access to: non-volatile memory 3 for storing a hash program 354 and a private key 355 of the trusted device 24, and volatile memory 4 for storing acquired integrity metric in the form of a digest 361. In appropriate embodiments, the volatile memory 4 may also be used to store the public keys and associated ID labels 360a-360n of one or more authentic smart cards 19 that can be used to gain access to the platform 10.

Exemplary processes for acquiring and verifying an integrity metric are described in detail in the applicant's co-pending International Patent Application Publication No. PCT/GB00/00528.

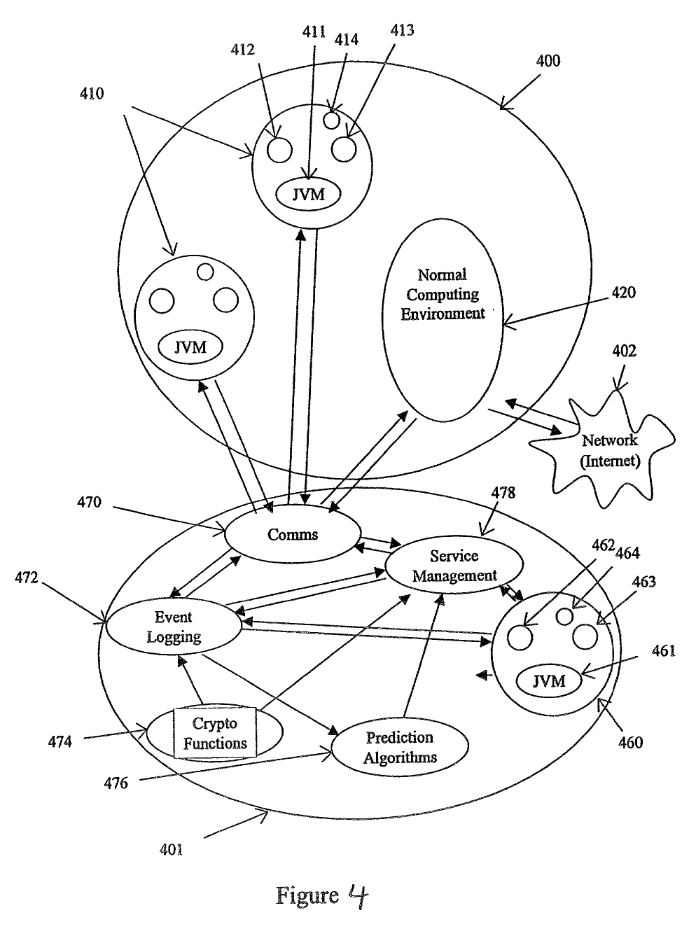

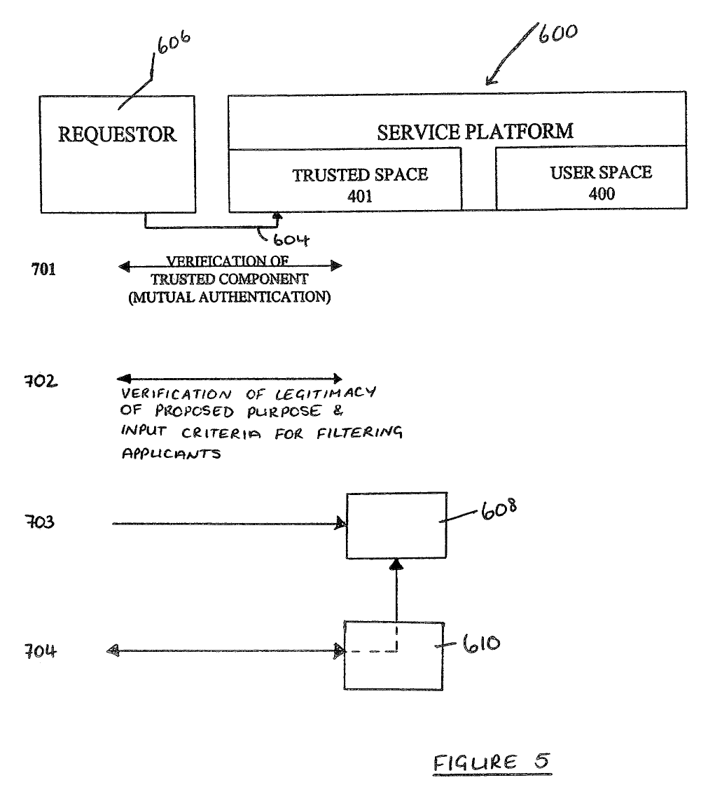

With reference to FIG. 4 of the drawings, the logical architecture of a trusted computing platform which could be employed in an exemplary embodiment of the present invention will now be described.

The logical architecture shown in FIG. 4 shows a logical division between the normal computer platform space 400 and the trusted component space 401 matching the physical distinction between the trusted component 24 and the remainder of the computer platform. The logical space (user space) 400 comprises everything physically present on motherboard 20 of the computer platform 10 other than trusted component 24: logical space (trusted space) 401 comprises everything present within the trusted component

User space 400 comprises all normal logical elements of a user platform, many of which are not shown here (as they are of no particular significance to the operation of the present invention) or are subsumed into normal computing environment 420, which is under the control of the main operating system of the trusted computing platform. The logical space representing normal computing environment 420 is taken here to include normal drivers, including those necessary to provide communication with external networks 402 such as the Internet (in the examples described herein, this is the route taken to communicate with the requester(s) of a private virtual room from the trusted platform or service-provider)

Also subsumed here within the normal computing environment 420 logical space are the standard computational functions of the computing platform. The other components shown within user space 400 are compartments 410. These compartments will be described further below.

Trusted space 401 is supported by the processor and memory within trusted component 24. The trusted space 401 contains a communications component for interacting with compartments 410 and normal computing environment 420, together with components internal to the trusted space 401. It is desirable that there be secure communications path between the normal computing environment 420 and the trusted space 401 (see the applicant's co-pending International Patent application No. PCT/GB00/00504, filed on Feb. 15, 2000, the contents of which are incorporated herein by reference)—alternative embodiments may include a direct connection between trusted space 401 and external networks 402 which does not include the user space 400—in the present arrangement, information that is only to be exchanged between the trusted space and a remote user will pass encrypted through user space 400. The trusted space 401 also contains: an event logger 472 for collecting data obtained from different operations and providing this data in the form desired by a party who wishes to verify the integrity of these operations; cryptographic functions 474 which are required (as described below) in communication out of the trusted space 401 and in providing records within the trusted space 401 (for example, by the event logger 472); prediction algorithms 476 used to determine whether logged events conform to what is expected; and a service management function 478 which arranges the performance of services which are to be performed in a trusted manner (it would be possible in alternative embodiments for service management function to reside in the user space 400, although this would require a larger amount of encrypted communication and monitoring of the service management function 478 itself—residence of the service management function 478 within the trusted space 401 provides for a simpler solution). Also resident within the trusted space 401 is a trusted compartment 460.

Compartments 410, 460 will now be described further. A compartment 410, 460 is an environment containing a virtual computing engine 411, 461 wherein the actions or privileges of processes running on these virtual computing engines are restricted. Processes to be performed on the computing engine within a compartment will be performed with a high level of isolation from interference and prying by outside influences. Such processes are also performed with a high level of restriction on interference or prying by the process on inappropriate data. These properties are the result of the degree of reliability, because of the restrictions placed on the compartment, even though there is not the same degree of protection from outside influence that is provided by working in the trusted space.

Also contained within each compartment 410, 460 is a communications tool 412, 462 allowing the compartment to communicate effectively with other system elements (and in particular with the trusted space 401 by means of communications tool 470), a monitoring process 413, 463 for logging details of the process carried out on the virtual computing engines 411, 461 and returning details to the event logger 472 in the trusted space 401, and memory 414, 464 for holding data needed by the virtual computing engines 411, 461 for operation as a compartment and for use by the process element allocated to the compartment.

There are two types of compartment shown in FIG. 4. Compartments 410 are provided in the user space 400, and are protected only through the inherent security of the compartment. Compartments 410 are thus relatively secure against attack or corruption. However, for process elements which are particularly critical or particularly private, it may be desirable to insulate the process element from the user space 400 entirely. This can be achieved by locating a “trusted” compartment 460 within the trusted space 401—the functionality of compartment 460 is otherwise just the same as that of compartment 410. An alternative to locating a trusted compartment 460 physically within the trusted device 24 itself is to locate the trusted compartment 460 within a separate physical element physically protected from tampering in the same way that trusted device 24 is protected—in this case it may also be advantageous to provide a secure communications path between the trusted device 24 and the tamper-resistant entity containing the secure compartment 460.

Trusted compartments 460 provide a higher level of trust than compartments 410 because the “operating system” and “compartment protections” inside trusted module 24 may be hard coded into hardware or firmware, and access to data or processes outside the trusted space 401 governed by a hardware or firmware gatekeeper. This makes it extremely difficult for a process in a trusted compartment to subvert its controls, or be affected by undesirable processes.

The number of protected compartments 460 provided is a balance between, on the one hand, the amount of highly trusted processing capacity available, and on the other hand, platform cost and platform performance. The number of compartments 410 available is less likely to affect cost significantly, but is a balance between platform performance and the ability to gather evidence about executing processes.

Aspects of the invention relate to the use of a service-provider (preferably a trusted computing platform) to perform a service for a requester, where the requester requires the service to be performed in a specific manner. In particular, the requester requires the provision of a private virtual room for a particular purpose, to be accessible only to parties satisfying certain predefined criteria. The requester may also be able to specify the level of security required, thereby choosing between a compartment 41 and a ‘trusted’ compartment 460.

FIG. 5 illustrates the main elements of a process in accordance with embodiments of the present invention by which a requester arranges for a service to be performed on a service platform as shown in FIG. 4. The initial step is for the requester to verify that the service-provider is a trusted computing platform by authenticating the trusted component 24 in step 701—this process is essentially as described above with reference to the acquisition and verification of an integrity metric. This process may be one of mutual authentication—the service-provider may require that the requester also be a trusted computing platform before performing the requested service.

In general, the present invention enables the provision of a private virtual room for use as a meeting place for e-participants who may not know each other in order to communicate, trade or carry out business in a safe environment. The issues addressed by the present invention include the provision of a secure virtual room, ensuring that the virtual room is private, ensuring that unwanted third parties cannot “listen in” on other parties' interactions, and achieving non-repudiation in connection with transactions performed within a private virtual room.

Thus, referring back to FIG. 5 of the drawings, in a first embodiment of the present invention, there is provided a service-provider 600, most conveniently provided in the form of a server, including a physically and logically protected computing environment 401, which is beneficially that provided by a “trusted component” as described in the applicant's co-pending International Patent application No. PCT/GB00/00528 entitled “Trusted Computing Platform” and filed on Feb. 15, 2000, and a user space 402.

In use, following the mutual authentication step 701, the trusted service-provider 600 accepts a request 604 to provide a private virtual room for a particular purpose from a customer or multiple customers 606. At 702, it then checks the legitimacy (and/or legality) of the proposed purpose, and possibly registers this with a tax system. It also seeks input about the criteria for filtering the participants, which may, for example, be input by the requester(s) of the private virtual room or may be retrieved from a database in which may be stored standard sets of criteria for filtering participants in connection with a variety of different predefined purposes.

Provided the legitimacy of the proposed purpose is verified, and the requester(s) meet the criteria for filtering participants (if applicable), at 703 the service-provider 600 sets up the private virtual room 608 which provides a secure environment within which participants can communicate electronically. At 704, the service-provider 600 receives requests from potential participants 610 to enter the virtual room 608 and, prior to permitting entry of such potential participants 610 to the virtual room 608, it filters the participants 610 to ensure that they meet the previously-defined criteria. Entry to the virtual room 608 is only permitted if a participant 610 meets all of the criteria. One method of doing this is by way of a mutual authentication and trust rating system, which may be performed/provided by the service-provider (or it may rely on data held by another party to provide such a rating).

In one exemplary embodiment of the invention, a trusted third party or parties may also be involved to ensure safety and correct procedure. For example, the service-provider 600 may allow such third parties to enter the virtual room 608 and be party to the communication within it, preferably by prior agreement with the customers 606 and/or participants 610. It will be appreciated that, in this case, the third party or parties must be trusted by both the customers 606 and the service-provider 600.

In a preferred embodiment of the present invention, the or each virtual room 608 is run in a physically and logically protected computing environment, e.g. a compartment, so as to protect it from outside influences.

In this preferred embodiment of the present invention, the service-provider 600 is arranged to carry out integrity checks on the hardware and software environment before setting up a virtual room 608, and only setting up the virtual room 608 if the environment is suitable, i.e. allowed according to a predetermined policy definition. This could be achieved by means of the trusted platform integrity checking mechanism described in the applicant's co-pending disclosure International Patent Application Publication No. PCT/GB00/02003 ‘Data Integrity Monitoring in Trusted Computing Entity’, filed on May 25, 2000. By such means, the service-provider 600 is able to offer assurance that there is no interference from unwanted software (including monitoring and reporting software) on the computing environment. In addition, the service-provider 600 is preferably arranged to carry out integrity checks on the software environment once the virtual room 608 is in use, to ensure that the computing environment has not been compromised during run-time. Once again, this could be achieved by the trusted platform integrity checking mechanism described in the above-mentioned disclosure.

Thus, in a preferred embodiment of the invention, a secure virtual room for communication and trading is provided by hosting the service on a trusted platform and running each room within its own compartment on the trusted platform, checking that the trusted platform has the requisite properties of compartmentalisation and safe environment via integrity checking on the platform. By such means, data and processing conducted in the room, and communication with the room, is accessible only to active participants in a room. The room is made private by checking the credentials of applicants to enter the room—the service-provider only permits entry into the room of those applicants satisfying the relevant predefined common criteria. Entry conditions are associated with the room, and the condition is preferably published, with guaranteed integrity, at least to participants in the room. As stated above, in order to gain entry into the room, a prospective participant must demonstrate that they meet the entry conditions, and the room guarantees that it only admits participants who have demonstrated that they meet the conditions. Thus, all participants know that all other participants in a room also meet the entry conditions, a fact on which they may depend during discussions and/or transactions carried out in the room.

Of course, the entry condition need not depend on the identity of the participant. The room may be set up so that nothing which can be observed by a participant can be used to identify any participant outside the room, except for (say) external references explicitly included by a participant in an interaction with other participants. It should be borne in mind that in a completely anonymous room, provision should be made for the fact that interactions observed by a participant cannot be correlated so as to reveal which set are initiated by the same participant, i.e. data provided by the participant within the interactions may suggest a correlation, but the room does not label the interactions in any way that can be used to distinguish a participant. In a pseudonymous room, the apparatus is beneficially arranged such that the room labels interactions with the identity of the initiating participant.

The apparatus may also be arranged such that the room reveals at least one attribute of the participant(s), especially where that attribute is part of the entry condition. For example, the room may have an age limit (e.g. 18-30) and may label interactions with the age of the participant, but nothing else. It should also be borne in mind that a person who can demonstrate eligibility for entry to a room may be acting under duress and the direct instructions of one who cannot. Thus, control of the physical access point is preferably provided so that the room can detect this.

It is preferred that only encrypted data is able to enter or leave a compartment. In a preferred embodiment, the service-provider 600 is provided with hardware means for encrypting such data, such that it can only be decrypted with permission of the service-provider 600.

In order to achieve non-repudiation, logs are produced and stored in protected storage means (not shown). For example, the apparatus could be arranged such that the logs are stored using a key known only to the service-provider 600. In a preferred embodiment, a private root key is generated within hardware owned by the service-provider, and a protected storage mechanism used by which the log could be stored in such a way that it is only accessible via a trusted hardware component within the computing apparatus.

The service-provider 600 may offer a service to spawn agents for participants, or to accept agents as participants so that such agents may act on the customer's behalf within one or more virtual rooms. The apparatus may include the feature whereby such agents may ‘die’ in the rooms, with or without having first returned information to the customer or service-provider (for example, to be logged or forwarded to the customer).

The service provider itself is preferably provided by a computer platform having a physically and logically protected computing environment, e.g. a “trusted component” as described in the above-referenced co-pending International Patent Application No. PCT/GB00/00528, and the trusted service-provider's software could itself be integrity checked as an extension of the secure boot process of the computing apparatus so that it cannot be subject to accidental or unauthorised alteration. This can be considered a direct extension of the data integrity checking mechanism described above.

In one embodiment of the invention, the service-provider provides only the necessary hardware to provide the service, with a fourth party providing some subset of the other functionality described above. In this case, the service provider and the fourth party are preferably arranged to mutually authenticate, and the fourth party would preferably be arranged to integrity check the hardware provided by the service-provider before the service could actually be provided.

Embodiments of the present invention have been described above by way of examples only, and it will be apparent to persons skilled in the art that modifications and variations can be made without departing from the scope of the invention as defined in the appended claims.

1) Apparatus for providing a private virtual room within which two or more parties can communicate electronically, the apparatus comprising means for receiving a request from at least one party to provide said virtual room, said request including information regarding the proposed purpose of said virtual room, the apparatus further comprising means for verifying the legitimacy of said proposed purpose and providing said virtual room only if said proposed purpose meets one or more predetermined criteria.

2) Apparatus according to claim 1, comprising means for receiving a request from at least one party to enter said virtual room, means for defining predetermined criteria for entry into said virtual room, and means for permitting a party to enter said virtual room only if said party satisfies said predetermined common criteria.

3) Apparatus according to claim 1, comprising means for running said virtual room within its own physically and logically protected computing environment.

4) Apparatus according to claim 3, comprising means for verifying the integrity of data within the or each said environment.

5) A server programmed for providing a private virtual room within which two or more parties can communicate electronically, the server being programmed on receiving a request from at least one party to provide a virtual room, wherein said request includes information specififying a proposed purpose of said virtual room, to verify the legitimacy of said proposed purpose and to provide said virtual room only if said proposed purpose meets one or more predetermined criteria.

6) Apparatus according to claim 5, comprising means for receiving a request from at least one party to enter said virtual room, means for defining predetermined criteria for entry into said virtual room, and means for permitting a party to enter said virtual room only if said party satisfies said predetermined common criteria.

7) Apparatus according to claim 5, comprising means for running said virtual room within its own physically and logically protected computing environment.

8) Apparatus according to claim 7, comprising means for verifying the integrity of data within the or each said environment.

9) Apparatus for providing a private virtual room within which two or more parties can communicate electronically, the apparatus comprising means for providing at least one virtual room and for running said virtual within its own physically and logically protected computing environment, and means for verifying the integrity of data within the or each said environment.

10) Apparatus according to claim 1, comprising means for determining if a user computing platform includes a logically and physically protected computing environment.

11) Apparatus according to claim 1, adapted to provide a plurality of private virtual rooms upon demand, each of the virtual rooms being run in a logically and physically protected computing environment.

12) Apparatus according to claim 11, arranged such that only encrypted data is permitted to enter or leave a logically and physically protected computing environment.

13) Apparatus according to claim 12, comprising encryption means for encrypting data entering or leaving a logically and physically protected computing environment, the apparatus being arranged such that the data can only be decrypted with permission of said apparatus.

14) Apparatus according to claim 1 including means for performing integrity checks on its hardware and software environment prior to providing a private virtual room, and only setting up such a virtual room if the environment is determined to the suitable.

15) Apparatus according to claim 1, comprising means for performing integrity checks on its software environment while a private virtual room is in use.

16) Apparatus according to claim 2, comprising means for displaying or otherwise providing details of one or more attributes of a user of a private virtual room to other users of the virtual room.

17) Apparatus according to claim 1, comprising means for producing logs of the communication or interaction taking place within a private virtual room and storing the logs in a protected storage means.

18) Apparatus according to claim 17, wherein said logs are stored using a key known only to the apparatus.

19) A method of providing a private virtual room within which two or more parties can communicate electronically, the method comprising the following steps: one party issues a request to a service provider to provide a virtual room, the request including information regarding the proposed purpose of the virtual room; the service provider verifies the legitimacy of the proposed purpose; and the service provider provides the virtual room only if the proposed purpose meets one or more predetermined criteria.

20) A method according to claim 19, further comprising the following steps: the service provider establishes criteria for entry into said virtual room; a party requests entry to the virtual room from the service provider; and the service provider permits the party to enter the virtual room only if said party satisfies said established criteria for entry.

21) A method according to claim 20, wherein the criteria for entry are established by the request to provide a virtual room.

22) A method according to claim 20, wherein the criteria for entry are established in accordance with predetermined criteria for the proposed purpose of the virtual room.

23) A method according to claim 19, comprising the step of running said virtual room within its own physically and logically protected computing environment.

24) A method according to claim 23, including the step of verifying the integrity of data within the or each said environment.

25) A method as claimed in claim 19, wherein the request comprises a user-specified purpose for the virtual room.

26) A method of providing a private virtual room within which two or more parties can communicate electronically, the method comprising the steps of a service provider providing at least one virtual room and running virtual room within its own physically and logically protected computing environment, and the service provider verifying the integrity of data within the or each said environment.

27) A method according to claim 26, further comprising the step of one party requesting the service provider to provide said virtual room, said request including information regarding the proposed purpose of said virtual room, the service provider verifying the legitimacy of said proposed purpose and providing said virtual room only if said proposed purpose meets one or more predetermined criteria.

28) A method according to claim 16, further comprising the steps of a party requesting the service provider to allow that party to enter said virtual room, the service provider defining criteria for entry into said virtual room, and permitting the party to enter said virtual room only if the party satisfies said predetermined common criteria.

29) A method according to claim 19, comprising the step of determining if a user computing platform includes a logically and physically protected computing environment.

30) A method according to claim 19, further comprising the steps of performing integrity checks on the hardware and software environment prior to providing a requested private virtual room, and only setting up such a virtual room if the environment is determined to be suitable.

31) A method according to claim 19, further comprising the step of performing integrity checks on the software environment while a private virtual room is in use.

32) A method according to claim 20, further comprising the step of displaying or otherwise providing details of one or more attributes of a user of a private virtual room to other users of the virtual room.

33) A method according to claim 19, further comprising the step of producing logs of the communication or interaction taking place within a private virtual room and storing the logs in a protected storage means.
